(19) United States
(12) Patent Application Publication
(10) Pub. No.: US 2007/0090295 A1
(43) Pub. Date: Apr. 26, 2007

(54) Image processing system

(75) Inventors: Nicholas James Parkinson, Worcestershire (GB); Paul Antony Manning, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED, London (GB)

(21) Appl. No.: 10/561,349

(22) PCT Filed: Jun. 21, 2004
(86) PCT No.: PCT/GB04/02676

§ 371 Date: Dec. 19, 2005

(30) Foreign Application Priority Data
Jun. 20, 2003 (GB) 0314422.7

(51) Int. Cl. G01J 5/02

(52) U.S. Cl. 250/349

(57) ABSTRACT

An image processing system includes a plurality of vertically arranged linear arrays of detectors imaged onto a plurality of areas in a scene of interest. Horizontal movement of an object through the plurality of areas of interest are detected and fed into a processor. The processor may detect object range, direction of movement, speed, true direction of travel, object type. The detectors may be sensitive in the infra red (IR), microwave (including mm wave devices), or visible wavebands, operating with ambient or artificial illumination. In some application a combination of IR and visible detectors may be used. Preferably each detector in the linear array has an associated amplifier and filter. A 360° cover may be obtained by combining several systems into a single unit. The system may be used to detect objects and then control operation of a higher definition two-dimensional detector array and camera.

### BACKGROUND

Examples of these systems are in thermal imaging where a parallel array of detectors is scanned across a scene by rotating prisms and/or flapping mirrors. Usually these detectors are also given a vertical scan, and the resultant display is formed of a plurality of banded scans. One use of imaging systems is in traffic monitoring. For example checking on the number and type of vehicles passing onto a bridge, toll road, or city centre congestion monitoring. One example is described in GB 2154388, where a single fixed vertically arranged linear array of detectors monitors vehicles passing through the detectors field of view. Movement of the vehicles provides a horizontal scanning giving a two dimensional image that can be stored or transmitted to a remote location.

The above example has its limitations; it does not distinguish between opposite directions of movements and can not give information about movement away from the sensors.

This limitation is overcome; according to this invention, by the use of a plurality of vertically arranged detector arrays and comparison of signals received from each array.

According to this invention an image processing system includes a linear array of detectors imaged onto a scene of interest and a signal processor for storing an image received by the linear array when a detected object passes through the scene;

characterised by:

a plurality of linear arrays spaced substantially parallel to one another to image a plurality of areas of interest in a scene; and

signal processing for detecting images received by the plurality of arrays and determining direction and speed of movement detected.

The present invention therefore uses a plurality of linear arrays to image the scene. Movement of a target through the scene will be picked up first by one of the linear arrays and later by one or more of the other linear arrays. The direction of movement of the target can be easily determined by looking at the order in which the target passes the linear arrays. Further the speed of motion of the object can be determined by looking at the time difference between the target crossing the field of view of the linear arrays. It should be noted that the field of view of each linear detector array, i.e. the plurality of areas of interest, are generally different parts of the scene, that is the linear arrays do not image the same area from different viewpoints.

The signal processing preferably compares the perceived size of the object as imaged by each detector. Changes in size of the perceived object can be used as an indication of movement towards or away from the detectors. Hence a determination of true motion can be made. Further the image processor may be adapted to identify the detected object. This can allow an estimation of range to the detected target based on the size of the object detected by the system and the known size of the object.

Thus the present invention identifies an object of interest as it crosses the filed of view of a first linear array and identifies the same object as it later crosses the field of view of other linear arrays. Based on the different images captured by the different arrays and the time at which the object crosses the field of view it is possible to determine the direction of motion, including motion towards or away from the sensor, the speed of motion, the type of object and an estimate of range. The output of each array has equal importance and where there are more than two linear arrays it is possible that the field of view of one of the linear arrays is such that it does not detect the object passing but the system will still function effectively, e.g. the view of one linear array is obscured by another object in the scene. This allows rapid or even random placement of the sensor system.

The detectors may be sensitive in the infra red (IR), microwave (including mm wave devices), or visible wavebands, operating with ambient or artificial illumination. In some application a combination of IR and visible detectors may be used. The IR detectors may be uncooled resistance bolometer or pyroelectric detectors.

Preferably each detector in the linear array has an associated amplifier and filter. The use of linear arrays mean that there is space next to each detector element for electronics to improve the signal to noise ratio. Were a two dimensional array of detector elements used the close packing of the detector elements would mean any amplifying and filtering could only be applied to the signal after multiplexing which gives a reduced signal to noise ratio.

Several systems may be combined into a single unit and arranged to give 360° azimuthal coverage.

For most application the linear arrays will be arranged vertically, and movement of a target is horizontal through the scene. However, these are optimum relative conditions and the array alignment and target movement may depart substantially from these. It is however necessary that the target movement has a component orthogonal to a linear arrays alignment direction.

### BRIEF DESCRIPTION OF DRAWINGS

The invention will now be described, by way of example only, with reference to the accompanying drawings in which:

FIG. 1 is a schematic view of a single vertical detector array monitoring traffic along a road;

FIG. 2 is a view of both a two-dimensional array with amplifiers, and four vertical linear detector arrays with a separate amplifier associated with each detector element;

FIG. 3 is a schematic view of a multiple linear detector array and lens formed by four arrays;

FIG. 4 is a plan view of a four array system and shows images of a vehicle moving through four detector array fields and away from the detectors, thus the images get smaller on successive detections;

FIG. 5 is a block diagram of a processor for processing of the detector arrays;

FIG. 6 is a view of four vertical linear arrays arranged in pairs;

FIG. 7 is a view of two pairs of vertical linear arrays used to trigger an additional two-dimensional array of detectors;

FIG. 8 is a plan view showing four separate arrays of four vertical linear arrays for providing 360° azimuthal detection;

FIG. 9 is a flow chart showing an algorithm for the processing of a single linear array; and

FIG. 10 is a flow chart showing an algorithm for processing for automatic target validation.

### DESCRIPTION OF EMBODIMENTS

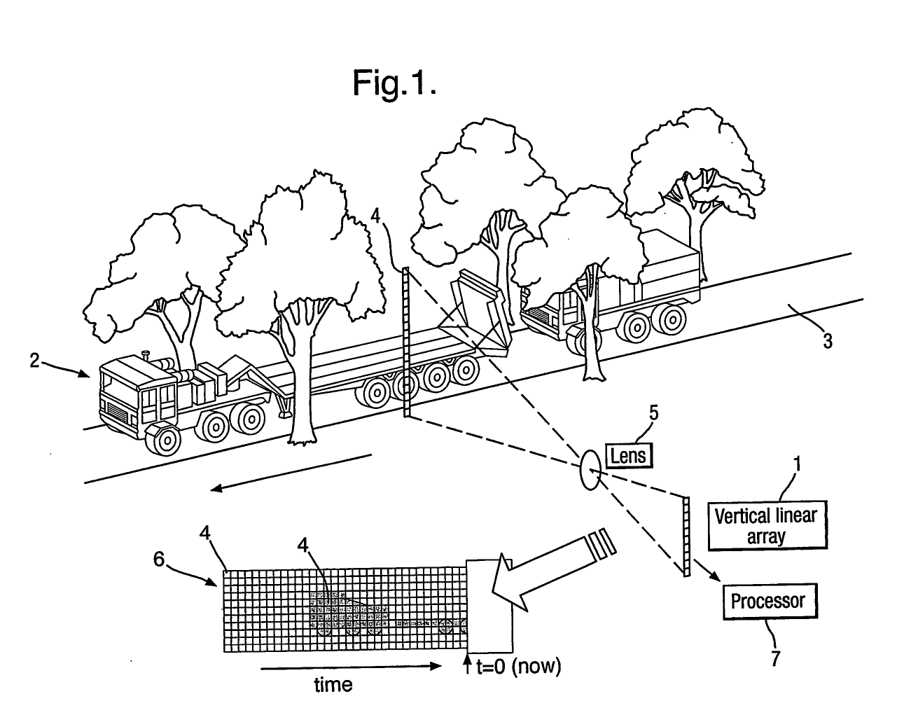

FIG. 1 shows the principles involved in a single vertical detector array 1 monitoring vehicles 2 movement along a road 3. The vertical array 1 receives an image 4 via a lens 5; typically the number of detectors in an array is 64 in a range of 32 to 128 or more. The image 4 is a thin strip 4 of detail from the vehicles 2 moving along the road 3. Successive images 4 are fed into memory 6 of a processor 7 for processing. The width of the stored image from a single vertical array 1 is dependent upon the speed of the vehicle 2 along the road and sampling speed of the array 1, typically between 5 and 50 times a second. Without vehicle movement no image is recorded if the detectors are pyroelectric detectors; such components measure temperature changes only (i.e. A.C. coupled), not steady state temperatures. Other forms of detectors, e.g. photodiodes or resistance bolometers respond to a steady-state input (i.e. D.C. Coupled).

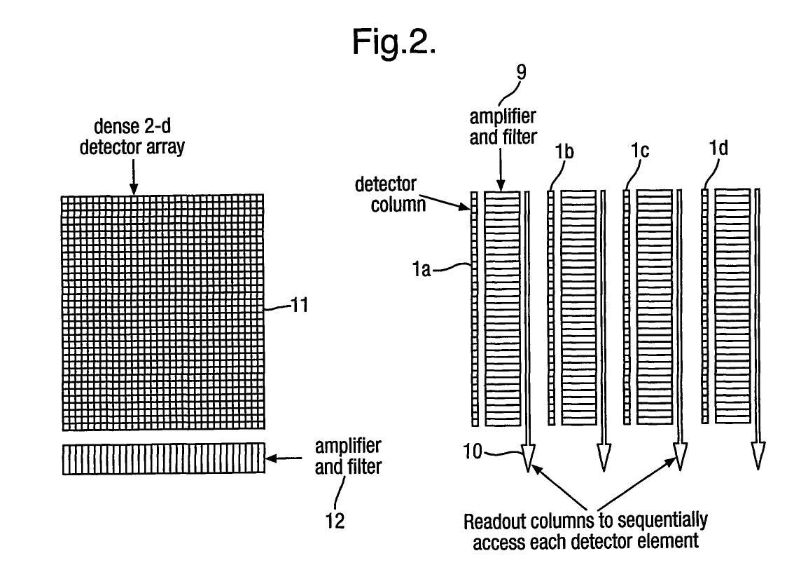

FIG. 2 shows four vertically arranged linear arrays manufactured in a sparse manner on a substrate 8 with room between each array for a column of electronic filters and amplifiers, with one amplifier and filter for every detector element. Readout electrodes 10 enable the output from each detector element to read out sequentially in a multiplexed manner. In comparison, a 2-d close packed array 11 is also shown with a set of amplifiers and filters 12.

The linear array 1 format has a distinct advantage over two-dimensional arrays 11 in terms of the signavnoise ratio that can be achieved. In a close packed array 11 there is no opportunity to limit the noise bandwidth until the signal has been multiplexed so the minimum noise bandwidth is the product of the frame rate and the number of pixels in a column. With a linear array 1 there is space to filter the signal from each pixel before multiplexing, which reduces the noise bandwidth and thus improves the signal/noise ratio. This may typically be achieved using compact low-power switched-capacitor filters, which can be readily implemented in CMOS technology. The array must be read out at sufficient speed that any target is sampled with sufficient resolution.

Each detector element may be made as described in WO/GB00/03243. In such a device a micro bolometer is formed as a micro-bridge in which a layer of e.g. titanium is spaced about 1 to 2 μm from a substrate surface by thin legs. Typically the titanium is about 0.1 to 0.25 μm thick in a range of 0.05 to 0.3 μm with a sheet resistance of about 3.3 Ω/sq in a range of 1.5 to 6 Ω/sq. The detector microbridge is supported under a layer of silicon oxide having a thickness of about λ/4 where λ is the wavelength of radiation to be detected. The titanium detector absorbs incident infra red radiation (8 to 14 μm wavelength) and changes its resistance with temperature. Hence measuring the detector resistance provides a value of the incident radiation amplitude.

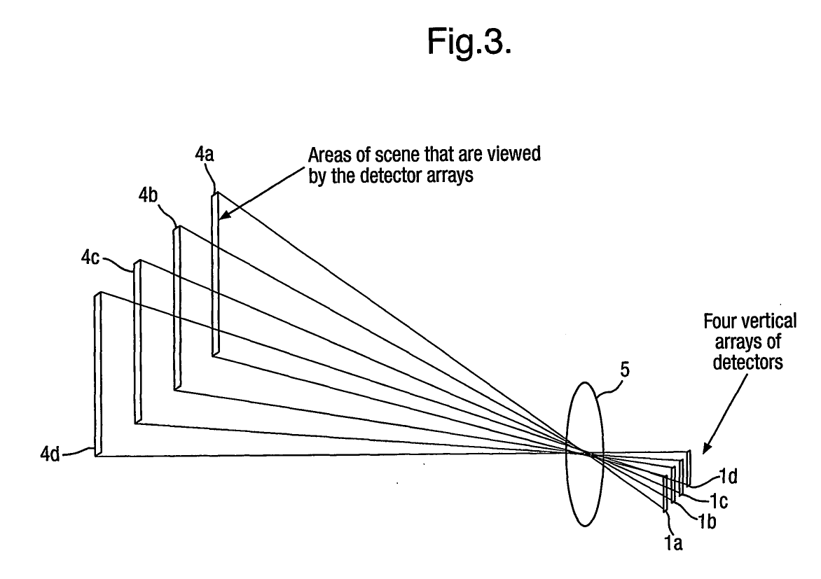

FIG. 3 shows a schematic view of a system using four vertically arranged linear detector arrays 1a-d for use as in FIG. 1; more or less arrays may also be used.

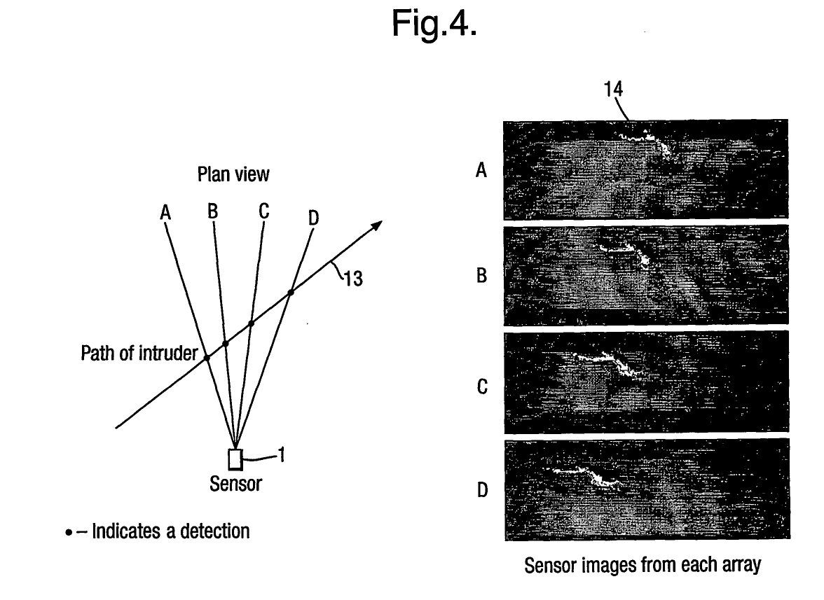

FIG. 4 shows a system with four linear arrays 1a-d, as in FIG. 3, marked A, B, C, D with a target object 13 moving successively through each detector beam with increasing distance away from the sensor arrays. Images 14 from each array are also shown; note that a vehicle's image becomes smaller as it moves away from the array. This allows the processor to estimate both radial movement and movement across the four arrays, i.e. calculate direction and speed of a target.

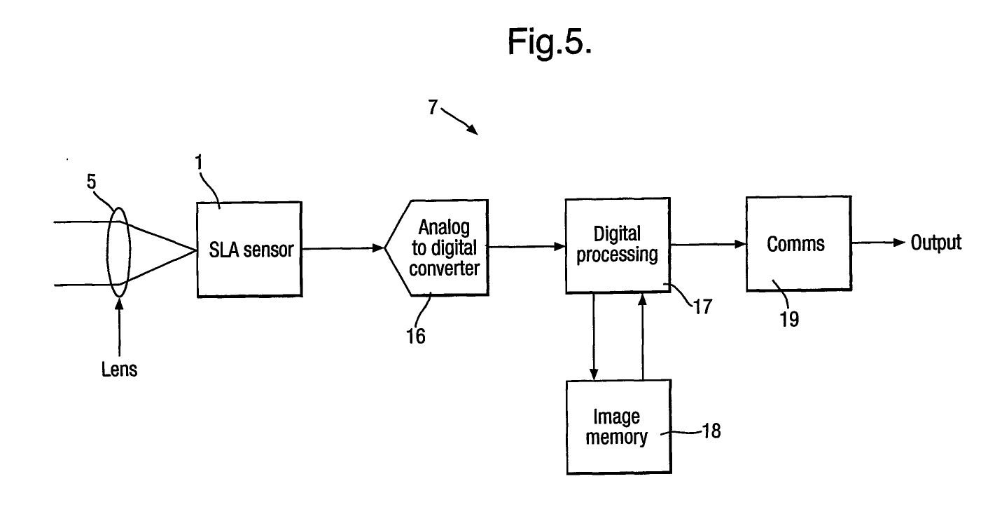

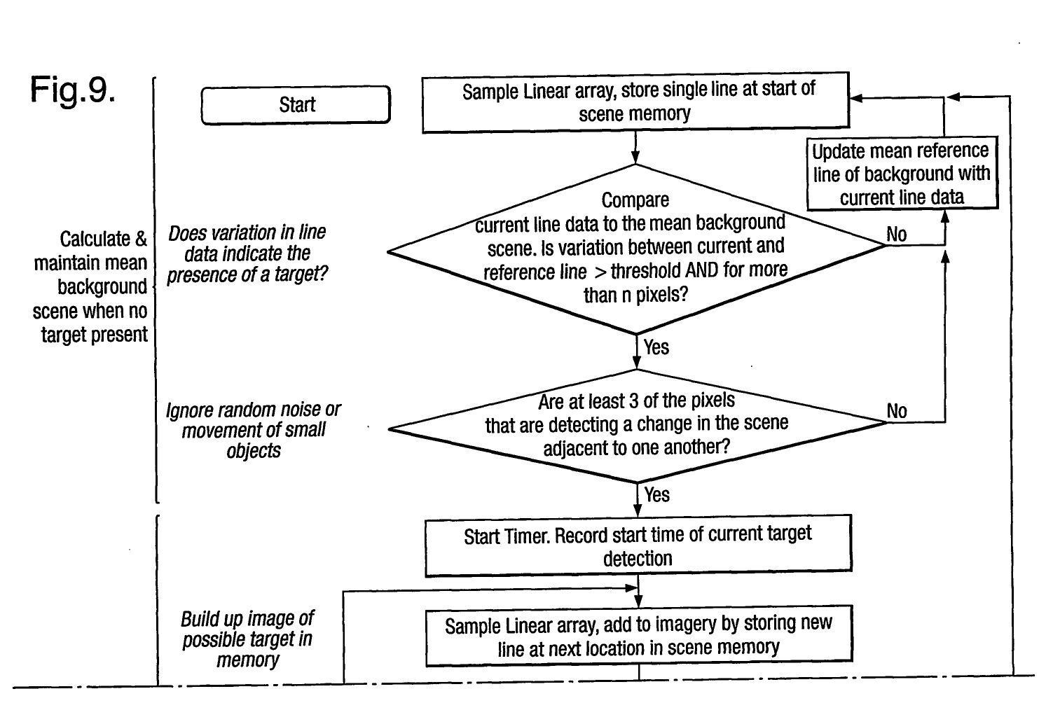

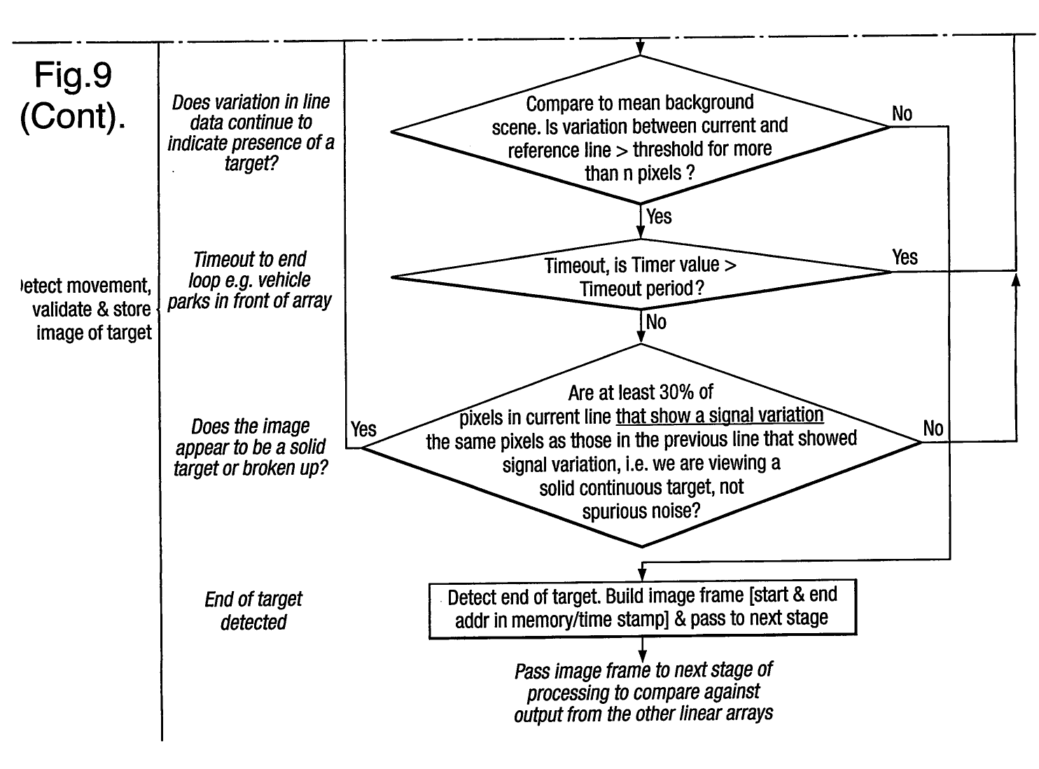

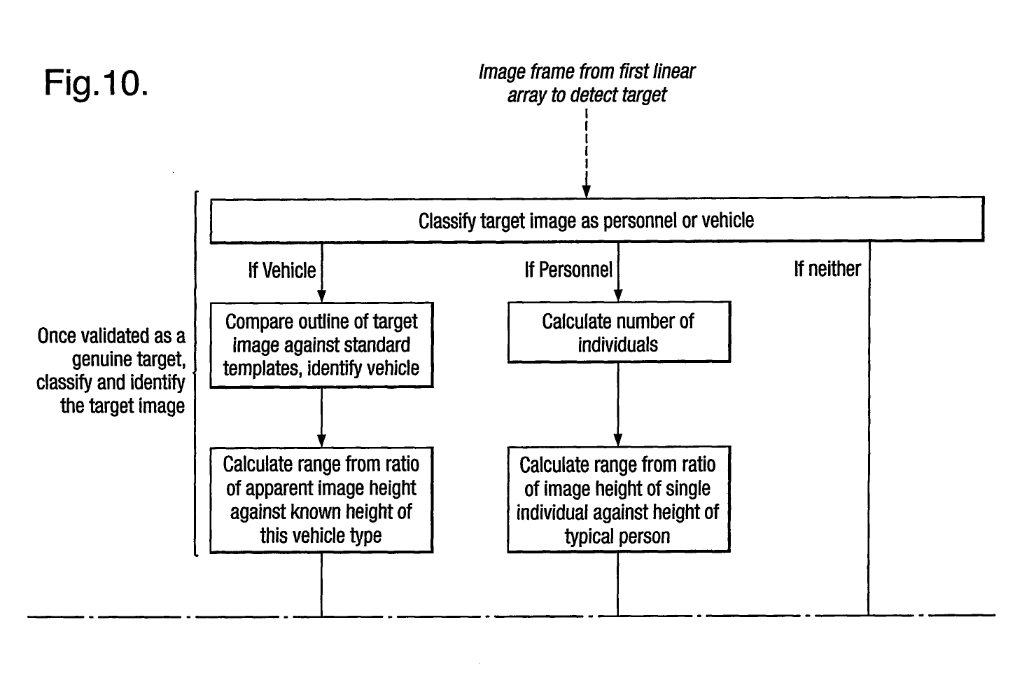

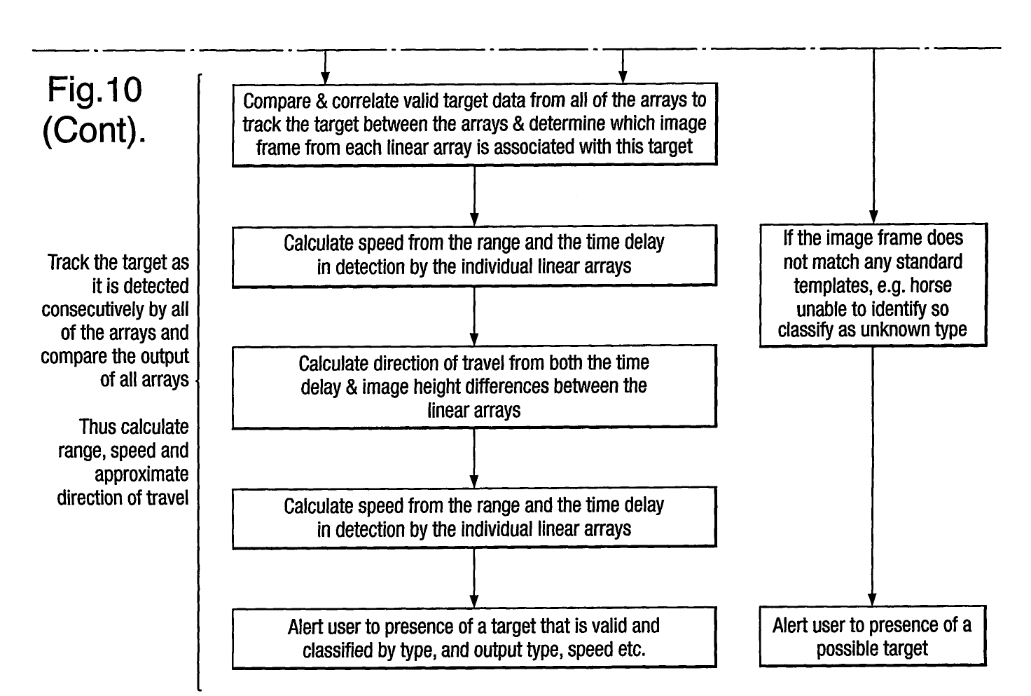

A block diagram of a processor for processing the output from a linear array is shown in FIG. 5. Image from a scene is focused onto all detectors in an array as in FIGS. 1, 3. Output is read sequentially from each linear array 1 via electrodes 10 into an A/D converter 16 and passed into a cpu digital processor 17. This cpu 17 carries out several steps as described later (FIGS. 9, 10), and also feeds into an image memory store 18, and into a communication module 19 whose output may be via landlines or radio to external receiving stations (not shown) to operators reading video monitors or to automatic detection systems.

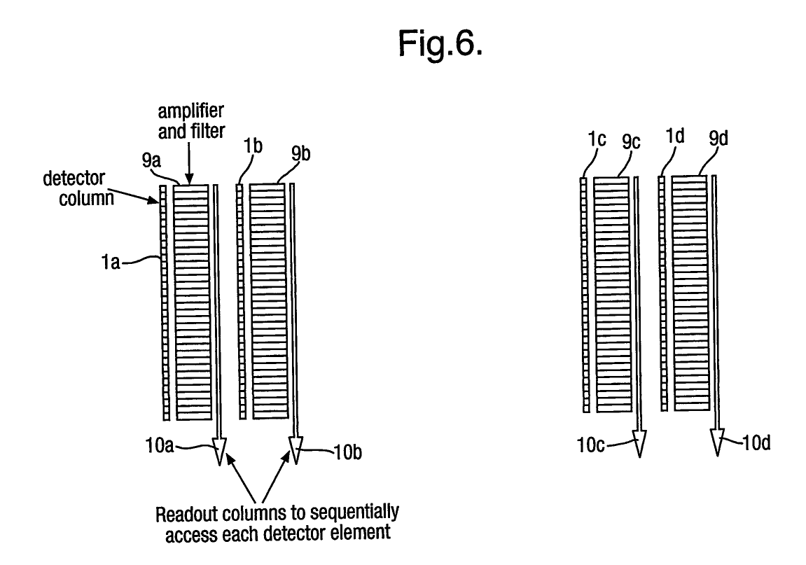

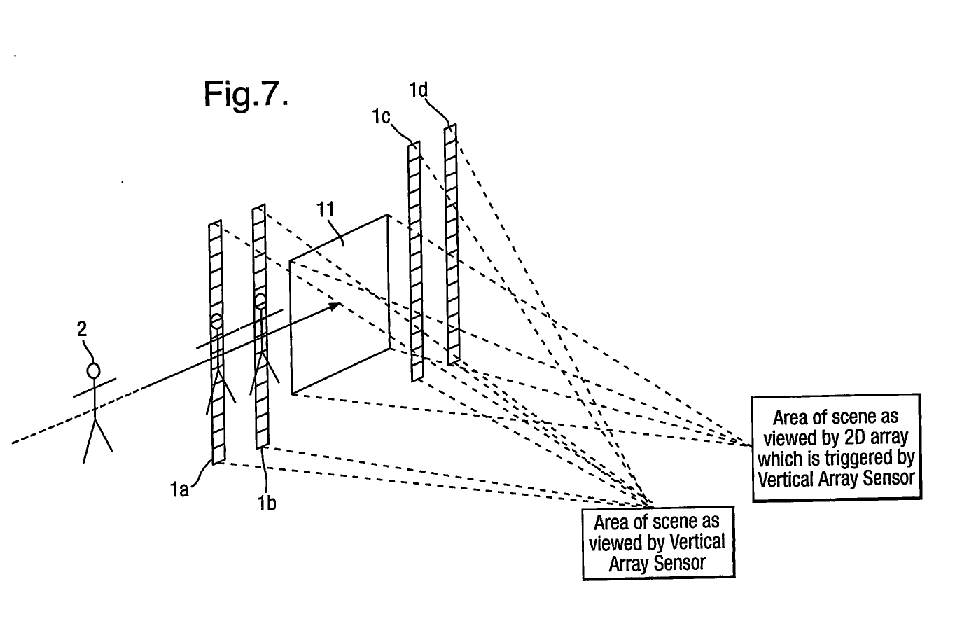

When operated as part of a larger system, the vertical array sensor format can be optimised for use in cueing other higher resolution 2-d imagers. The timing and positional information supplied by the sensor gives an additional cue for the location of the target at a given moment in time, see FIG. 7. In this case one or more vertical arrays could monitor the perimeter of the central area of interest, and a sensor format as shown in FIG. 6 would be more appropriate where the vertical arrays have been constructed with a wider gap between the central pair.

The purpose of using a linear array to cue another higher resolution 2-d imager is to reduce power consumption and enable coverage of a wider area than could be achieved with the high-resolution imager operating alone. In a system like this the 2-d imager only needs to operate for short periods of time when a target has been detected. This particularly important where it is also necessary to switch on artificial illumination in order for the 2-d array to provide a high quality image. The application of simple false alarm reduction techniques to the output of the vertical array can further reduce the number of occasions when the 2-d imager is cued. This reduction in power consumption is necessary for sustained operation of distributed sensor networks. It also allows a high-resolution imager with narrow field of view when mounted on a pan and tilt head to be cued by the processor to look at appropriate areas of interest, achieving high-resolution coverage of the area of interest within a wider field of view.

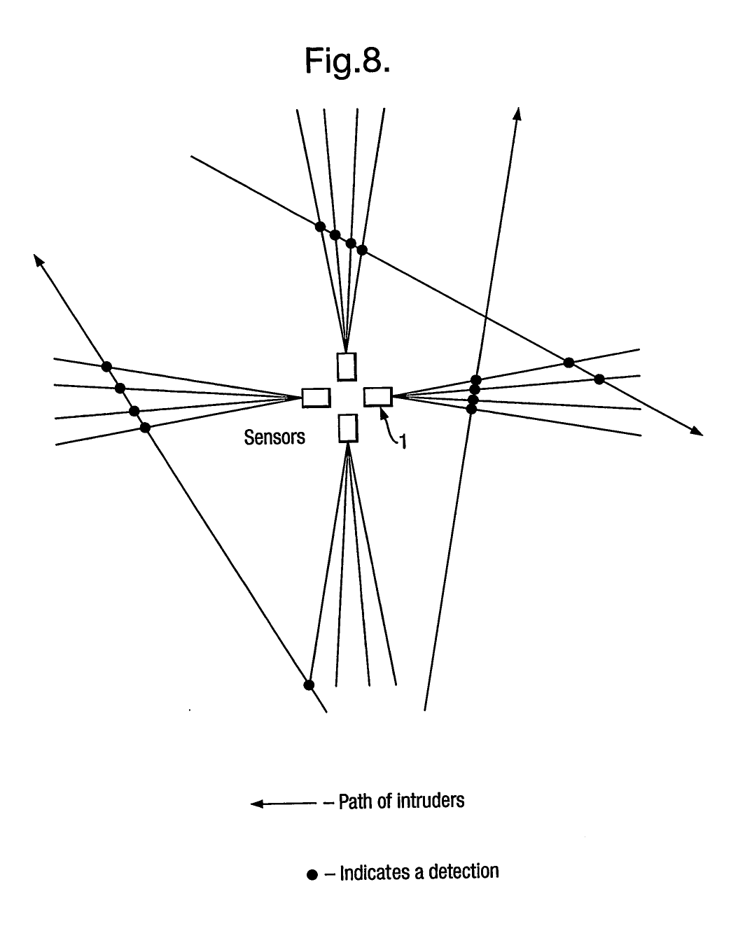

Extended coverage may be arranged by use of three or more systems. This is shown in FIG. 8 which shows a plan view of four systems, as in FIGS. 3, 4, arranged 90° apart to give all round azimuthal coverage. Increasing the number above four improves performance at the expense of further complexity.

FIGS. 9 and 10 show an example of a simple digital processing sequence that could process and interpret the data from these vertical arrays. The process shown in FIG. 9 outlines how movement is detected, false or spurious targets ignored and an image of the target constructed in memory for a single vertical array. The process shown in FIG. 10 outlines the order in which this image would be classified, the images from all of the vertical arrays in a sensor compared, and the range, speed and directional information derived from the combined information supplied by all of the arrays.

As can be seen it is practical to implement a simple analysis of the incoming data to reduce or eliminate false targets and spurious noise and clutter in the scene. Hence movement through the scene can be detected and targets of interest validated. Following this, further processing can classify the target and determine range, direction of movement, speed and finally an estimate of the true direction of travel.

Once in the memory 18 the image shape can be compared to stored standard templates of the typical imagery of vehicles and people as seen at the operating waveband of the detectors. In this manner the target can be classified as vehicle or personnel, and if a vehicle then the type of vehicle can be determined e.g. car, mini-van, truck, tractor, tank. The type of vehicle must be determined for the actual height of the target to be known and to enable the range, speed and directional information to be calculated.

By comparing the apparent height of the target image against the known typical height of this class of target the distance of the target from the linear arrays 1 can be calculated.

The time delay between the arrays in detecting the target and the now known distance to target can be used to calculate an estimate of the speed of the target.

As more than one vertical array is used further information can be obtained with regard to the target by tracking the target as it is detected consecutively by all of the arrays and comparing the outputs from each array against one another. For example, the direction of travel (e.g. either left-to-right or right-to-left) can be determined based on which array detects the target first.

And finally an estimate of the true direction of travel can be obtained by comparing the apparent size of the target in the images from each of the linear arrays and their relative timing.

1. An image processing system including a plurality of linear arrays of detectors imaged onto a scene of interest and an image store for receiving signals from the linear array when a detected object passes through the scene;
wherein
the plurality of linear arrays of detectors are spaced substantially parallel to one another to image a plurality of areas of interest in a scene; and
the system further comprises a signal processor for detecting images received by the plurality of arrays and determining direction and speed of movement detected.

2. The system of claim 1 wherein the detectors are infra red detectors.

3. The system of claim 1 wherein the detectors are visible light sensitive detectors.

4. The system of claim 1 wherein the detectors are mm wave sensitive detectors.

5. The system of claim 1 wherein each detector element in each linear array has associated therewith an independent noise limiting means.

6. The system of claim 5 wherein the noise limiting means at each detector element comprises an independent amplifier and filter.

7. The system of claim 1 wherein each detector array has its output read out sequentially from each detector element.

8. The system of claim 1 wherein the processor is arranged to determine at least one of detected object range, direction of movement, speed, true direction of travel, object type.

9. The system of claim 1 including an additional two-dimensional detector array system which may be switched on when an object is detected.

10. The system of claim 1 wherein several systems are combined into a single unit arranged to give about 360° of azimuthal coverage.

11. The system of claim 1 wherein outputs from the signal processor are communicated to remote monitoring stations.

12. (canceled)
